(19) United States
(12) Patent Application Publication
(10) Pub. No.: US 2015/0326973 A1
(43) Pub. Date: Nov. 12, 2015

(54) Portable Binaural Recording & Playback Accessory for a Multimedia Device

(71) Applicant: Matthew Marrin, Canyon County, CA (US)

(72) Inventor: Matthew Marrin, Canyon County, CA (US)

(21) Appl. No.: 14/715,238

(22) Filed: May 18, 2015

Related U.S. Application Data
(63) Continuation-in-part of application No. 14/272,635, filed on May 8, 2014.

(51) Int. Cl. H04R 5/033; G11B 20/10; H04S 7/00

(52) U.S. Cl. CPC H04R 5/033; H04S 7/30; G11B 20/10527

(57) ABSTRACT

A portable binaural recording and playback accessory for a multimedia device includes headphones with embedded outside facing microphones, a protective mobile electronic device case with embedded stereo microphone preamplifier or audio video codec containing a microphone preamplifier, analog to digital converter/digital to analog converter (or digital signal processor), and a battery, allowing for the recording and playback of high quality binaural audio, while at the same time acting as a protective case and as an additional power supply.

### CLAIM FOR DOMESTIC PRIORITY

This application incorporates by reference and is a continuation in part of U.S. patent application Ser. No. 14/272,635 filed May 8, 2014 and herein incorporates by reference all disclosed material and definitions therein.

### BACKGROUND

Smart phones and tablet computers have dominated consumer electronic sales in recent times, achieving a dominating presence in the lives of many. People now use their phones or tablet computers to read books, watch movies or television programs, listen to music, make telephone calls, record activities with portable, mountable camera/video recorders, and/or communicate via voice-over-IP with or without video data. Additionally, people are using smart phones and tablet computers for audio and video recording, from simply recording their own thoughts to recording conversations, business meetings, concerts, or education material such as presentations or podcasts. The accessibility and size of smart phones and tablet computers make them a quick and easy audio and video recording option. Unfortunately, recordings on phones will almost always be monophonic, reliant on the quality of the built-in microphone, creating a less than ideal audio recording.

### SUMMARY OF THE INVENTION

In accordance with the invention, headphones with embedded microphones connect to a protective mobile electronic device case which contains an audio/video codec and battery, allowing for the recording and playback of high quality binaural audio while at the same time acting as a protective case and an additional power supply. Additionally, for just audio recording and playback, a dongle can house the audio codec or even the headphones themselves. It has many of the advantages mentioned heretofore and many novel features that result in a new portable binaural recording and playback accessory for a multimedia device which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a perspective view of the binaural recording and playback accessory for a multimedia device of the present invention in use with a portable electronic device;

FIG. 2 is a perspective view of the headphones of the present invention;

FIG. 3 is an exploded view of the case and portable electronic device of the binaural recording and playback accessory for a multimedia device of the present invention;

FIG. 4A is a top view of the case of the binaural recording and playback accessory for a multimedia device of the present invention;

FIG. 4B is a right-side view of the case of the binaural recording and playback accessory for a multimedia device of the present invention;

FIG. 4C is a left-side case of the binaural recording and playback accessory for a multimedia device of the present invention;

FIG. 5 is a front view of the case of the binaural recording and playback accessory for a multimedia device of the present invention;

FIG. 6 is a rear view of the case of the binaural recording and playback accessory for a multimedia device of the present invention;

FIG. 7 is a perspective view of the case of an alternate embodiment binaural recording and playback accessory for a multimedia device of the present invention;

FIG. 8 is a rear-perspective view of the case of an alternate embodiment binaural recording and playback accessory for a multimedia device of the present invention;

FIG. 9 is a diagram illustrating the possible constituent parts of the audio/visual codec of the present invention;

FIG. 10 is a left-side perspective view of binaural recording and playback over-the-ear headphones of the present invention;

FIG. 11 is a right-side perspective view of binaural recording and playback over-the-ear headphones of the present invention;

FIG. 12 is a top view of binaural recording and playback over-the-ear headphones of the present invention;

FIG. 13 front view of binaural recording and playback over-the-ear headphones of the present invention;

FIG. 14 is a bottom view of binaural recording and playback over-the-ear headphones of the present invention;

FIG. 15 back view of binaural recording and playback over-the-ear headphones of the present invention;

FIG. 16 is a left-side view of binaural recording and playback over-the-ear headphones of the present invention;

FIG. 17 is a right-side view of binaural recording and playback over-the-ear headphones of the present invention;

FIG. 18 is a perspective view of the binaural recording and playback dongle of the present invention;

FIG. 19 is a top view of the binaural recording and playback dongle of the present invention;

FIG. 20 is a right-side view of the binaural recording and playback dongle of the present invention; and

FIG. 21 is front view of the binaural recording and playback dongle of the present invention.

### DETAILED DESCRIPTION

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As used herein the term “multi-media device” refers to a host of electronic equipment used to allow an individual to store, experience or work with video, audio or text media, including but not limited to cell phones, computers, computer tablets, video recorders/playback units, cameras, memory storage units, MP3 players, and the like.

As used herein, the term “headphones” refers to what is commonly known as a “set of headphones” with both left and right component headphone sides each having a left or right stereo speaker and a left or right stereo recording microphone therein.

As used herein, the term “earpiece” refers to one half of a set of headphones, specifically the right or left speaker and microphone combination. The earpiece can physically be configured as an earbud or earcup that is, or is not physically connected to the mating earpiece. The earpieces taken together may comprise a wired or wireless set of headphones.

As used herein, the term “head-related transfer function” (HRTF) refers to a response that characterizes how an ear receives a sound from a point in space; a pair of HRTFs for two ears can be used to synthesize a binaural sound that seems to come from a particular point in space.

As used herein the term “codec” is hardware, firmware, software, or a combination of hardware, firmware, and software that provides the architecture, which is configurable into a number of functional arrangements to accomplish the audio and video processing necessary for the device it is coupled to. Herein, as shown in most embodiments, it is incorporated into a microprocessor embedded into the dongle, the headphones or the case enclosures. It also may be incorporated into a dongle, the headphones or case when the level controls and all other functions are manual and without a microprocessor, as there is no actual automated processing occurring. The codec is configurable into a number of functional arrangements to accomplish the audio and video processing necessary. It may include microphone inputs, microphone preamplifiers, microphone amplifiers, analog to digital audio convertors, audio to digital signal processors, video digital signal processors, digital to analog audio convertors or any combination thereof. In its most basic form the codec employs only a microphone preamplifier and a digital audio convertor.

As used herein “communication means” refers to the equipment required to provided wireless or hard wired two way stereo communication between the headphones and external electronic devices.

As used herein the term “wireless communication means” refers to transmitting and/or receiving devices using any one of a set of electronic communication protocols established for the wireless transmission of electronic data including but not limited to IEEE 802.11 standards, marketed under the Wi-Fi brand name; the wireless technology standard for exchanging data over short distances (using short-wavelength UHF radio waves in the ISM band from 2.4 to 2.485 GHz marketed under the Bluetooth brand name; or 4G including LTE, Wibro Evolution (3.9G) and LTE-Advanced. It is synonymous with the term “near field communication means.”

As used herein the term “dongle” refers to a small piece of hardware that attaches to an electronic device in order to enable additional functions such as copy protection, audio or audio/video playback, games operation, data transmission, audio recording, or other services. These services are available only when the dongle is attached. Attachment does not need to involve a physical connection. The dongle may communicate with the device it enables wirelessly, via near field communication means.

As used herein “external electronic devices” refer to any of personal computing devices, multimedia devices, electronic musical instruments, stereo recording and playback devices, and data storage devices.

As used herein the term “audio to digital signal processor” is synonymous with what is known as digital audio signal processors.

As used herein the term “microprocessor” is a device that applies an alogorithmic function to control the signals and functionality between the accessory and one or more of the connected external electronic devices.

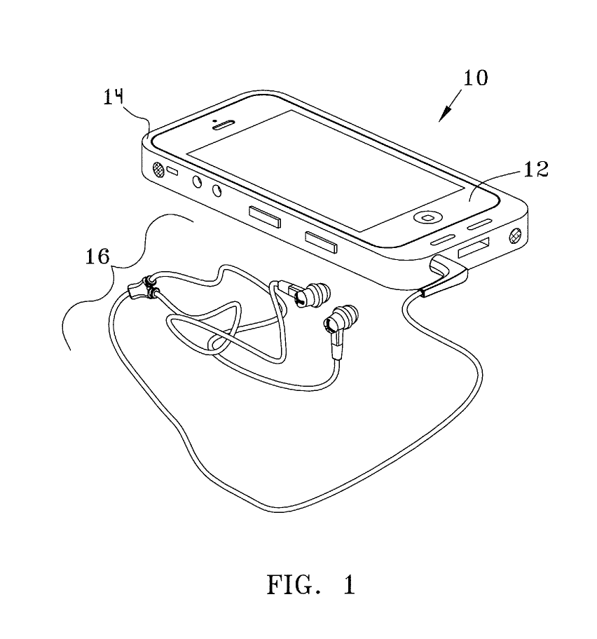

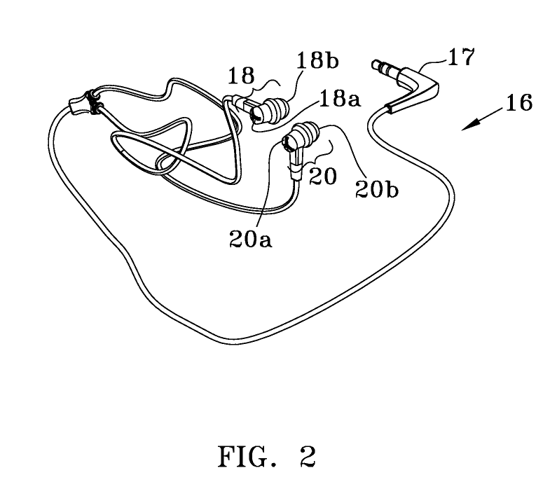

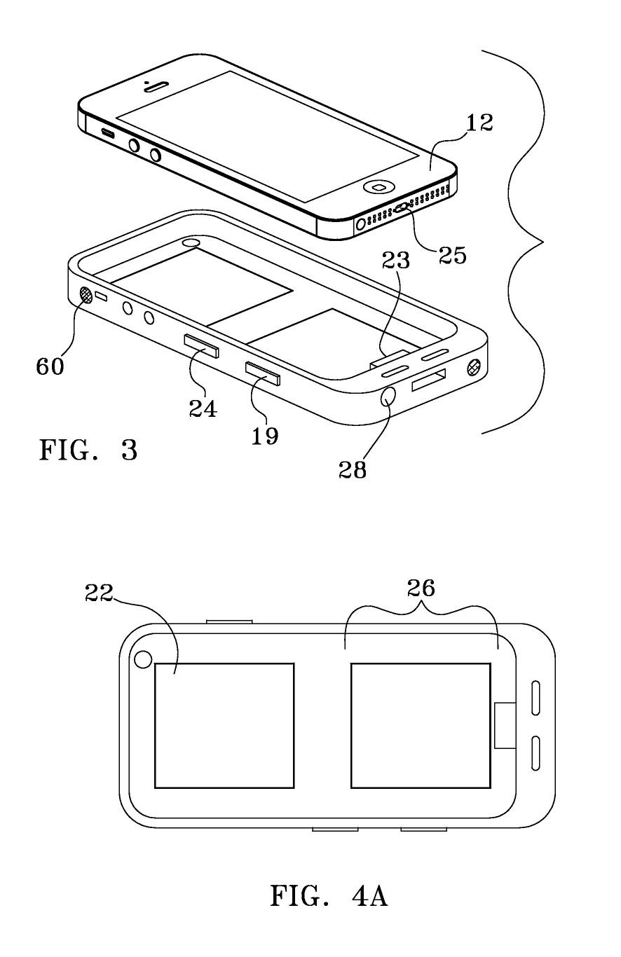

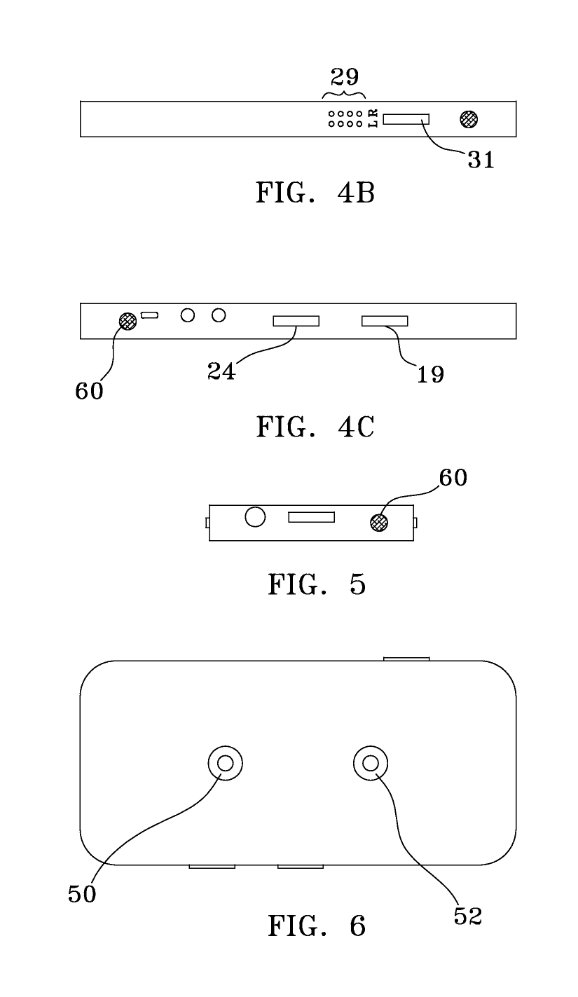

FIG. 1-2 illustrates the binaural recording and playback accessory for a multimedia device 10 of the present invention in use with a multimedia device 12. Accessory 10 comprises case 14 and earbud headphones assembly 16. The headphones assembly 16 comprises a right earpiece 18, a right earbud headphone speaker 18b, a right earpiece microphone unit 18a, a left earpiece 20, a left earbud headphone speaker 20b, and a left earpiece microphone unit 20a. As illustrated herein headphones assembly 16 incorporates wired earbud style audio headphones; however, circumaural (around-the-ear) audio headphones that are either closed back or open back could also be used without departing from the scope of the invention (in an open back design all ambient sound still “passes through” to the user simultaneously with the audio playing through the speakers).

Microphone units 18a and 20a are powered via what is known in the industry as “phantom power” (a minute electrical current passing to the microphone units through at least one of the same conductors that carry the microphone's right and left output signals.) In the preferred method of accomplishing this, (as in the preferred embodiment) the hard wiring of the headphones assembly 16 would utilize six conductors with three per side wherein a common negative conductor is utilized for both the microphones (18a, 20a) and headphone speakers (18b, 20b).

In the preferred embodiment, jack 17 is of a tip ring sleeve connector style, the design and operation of which is well known in the art. Jack 17 has two different regions (generally stepped in diameter) and an outer sleeve each connected to one of the three hard wires described above (not illustrated). Should an alternate embodiment have an additional microphone for capturing the user's speech (not illustrated) a seventh wire from this microphone would be required and the internal wiring for the connection to the jack 17 would be modified as would be well known in the industry.

Microphones 18a, 20a are outward facing (face away from the head of the user) and lie along the centerline of the ear canal, when placed in a user's ear. Microphones 18a, 20a are non-directional, capturing sound from all directions, partially limited only by any physical barriers. Thus, microphones 18a, 20a are aligned roughly with their central axis passing through the midpoint of the wearer's outer ear canal. In this way, the microphones are positioned to collect the exact same sound that would pass into the ear canal naturally or normally (e.g. without headphones on the ears). In this way the sound origin, direction, volume, frequencies, tonal response, etc., captured by microphones 18a, 20a will most closely approximate the sound collected (heard) by the users' ears at the time of a recording, essentially mimicking an Head Related Transfer Function (HRTF). When reproduced, this audio recording, that closely mimics the sound heard at the original source (the audio waves captured by the original listener), can be coordinated with any video captured from the same or connected, multimedia device 12. (The video processing would take place within the mobile electronics device.) This combination of audio and video will closely replicate the exact visual and auditory sensory feeling that the user had at the time of the recording.

Microphones 18a, 20a are enabled via switch 19 which is mounted on case 14. A visual indicator 29 of the of the respective input and output levels from the microphones 18a, 20a, is also located on case 14 and may comprise a series of LEDs. Recording level control is accomplished via a two-way switch 31, allowing the user to raise or lower the recording level. The switch 31 will be mounted in the case adjacent the visual indicator 29. Since the separate microphones face 180 degrees apart and are blocked by the mass of a human head not all sounds recorded by the microphones will have the same volume. The lower of the two recorded signal volumes must be detected in order to be recorded. Additionally, the higher of the two signals must be maintained below a maximum level for clarity. Switch 31 will allow both microphone sensitivities to be simultaneously adjusted upward or downward so as to insure a proper recording level is maintained as well as the stereo separation of the recorded signals. Although illustrated as wired, headphones 16, and hence microphones 18a, 20a, could easily be enabled for wireless transmission such as Wi-Fi, Bluetooth, 4G including LTE, Wibro Evolution (3.9G), LTE-Advanced, or otherwise enabled for wireless transmission of audio signals.

Case 14 internally contains one or more batteries 22 (not illustrated) which can be directed to serve as the primary power or reserve power for the multimedia device 12. In an alternate embodiment batteries 22 may also be designated to serve as the primary power source for the codec 26 and the headphones 16. Switch 24 allows the user to select the desired designation of the battery's power. Case 14 can be water resistant or even completely waterproof.

Headphone jack input hole 28 is incorporated into case 14 and is adapted to receive headphone jack 17 and is matingly conformed for proper electrical connection with the various six (or seven) conductors of the aforementioned jack 17. Input hole 28 facilitates the transfer of electronic signals in either direction—in reception or in transmission. Transmission occurs when sound/music is being played through the headphones 16 and phantom power is being sent to the microphone units 18a and 20a. Reception occurs when microphones 18a, 20a are recording.

Case 14 connects to multimedia device 12 via a male multi-pin interface connector 23 that matingly conforms to a female multi-pin interface connector 25 incorporated into the multimedia device 12 and that allows electrical continuity between the multimedia device 12's electronic features, the codec 26, and the headphones 16. It should be noted that male multi-pin interface connector 23 could vary in positioning within case 14 and size, depending on “style” of the female multi-pin connector 25 of the multi-media device to which it connects. Additionally, headphones 16 could easily be replaced by using an adaptor (connected to case 14 via input hole 28) to connect two external microphones of any type.

There is a series of hard wires imbedded between the male multi-pin interface connector 23, the codec 26 and the headphones 16. It is to be noted that input hole 28 in case 14 is hard wired for electrical contact to both the codec 26 and the male multi-pin interface connector 23. This allows a plethora of different operations. It is to be noted that the headphone jack input hole of the multimedia device 12 is not utilized with assembly 10, rather it is replaced with the headphone jack input hole 28 which is wired to the codec 26 and the male multi-pin interface connector. If the multimedia device's headphone jack input hole was used, then there would be no way to route any of the microphones output to codec 26 for processing. In this way the input signal from the microphones 18a, 20a is processed first by codec 26 prior to being transmitted to device 12, while the output signal from device 12 passes through codec 26 prior to being transmitted to headphones 16.

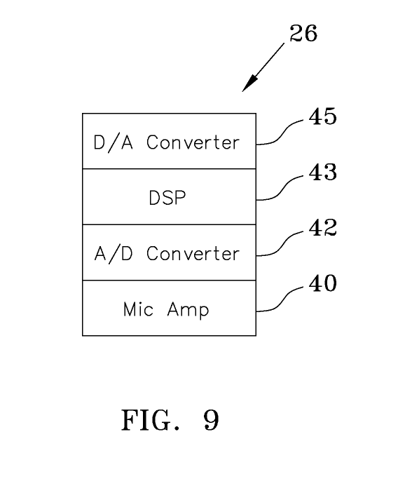

As the codec 26 may be configured in various ways and support various levels of operation, its hardware, firmware, software, or combination thereof that provides the architecture, which is configurable into a number of functional arrangements to accomplish the audio and video processing necessary for accessory, may include microphone inputs, microphone amplifiers, analog to digital audio convertor, audio to digital signal processor (digital audio signal processors), video digital signal processor, digital to analog audio convertor or any combination thereof (FIG. 9) However, in its most basic form codec 26 employs only a microphone preamp 40 to digital audio convertor 42.

Case 14 may include two embedded cameras 50, 52 adapted for stereoscopic video recording. In such an embodiment codec 26 would receive the two separate video signals from the cameras 50, 52 and process them appropriately for enhanced stereoscopic recording and playback via multimedia device 12. In this embodiment the initiation of a video recording by multimedia device 12 would not operate the local camera (that is the camera in device 12) but rather initiate operation and substitute the output of cameras 50, 52 into the multimedia device 12.

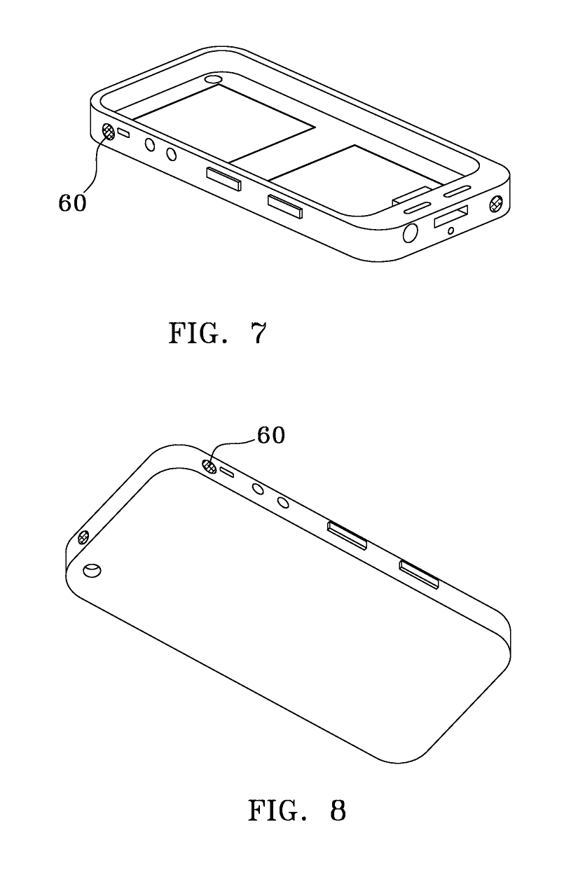

FIGS. 7 and 8 illustrate an alternate, second embodiment of case 14 wherein embedded microphones 60 into the sides and ends of case 14. This embodiment allows for headphone assembly 16 and its microphones 18a, 18b to be omitted. The user would only require case 14 to produce high quality recordings, and no headphones or external microphones would be needed. Embedded microphones 60 could be located on opposing sides of case 14, at opposing ends of case 14, or on the back of case 14, and codec 26 could choose which pair of microphones 60 to employ for recording (or use both pairs) depending on the orientation of the phone. Additionally, digital signal processing could be added to individual microphones 60 to enhance the recording effect. The digital signal processing could include filtering, dynamic delay, mid side decode, variable phase inversion, compression, limiting, beam-forming, HRTF filters, or any other digital signal processing technology. Microphones 60 are also visible in previous embodiments. It should be noted that microphones 60 can be embedded anywhere on case 14 without departing from the scope of the invention.

In operation, (playing headphones only) the digital audio output signal from the multimedia device 12 passes through the male and female pin connectors (23, 25) and is routed via hard wires to the codec's 26 digital/analog converter 44 where it is converted to an analog signal, and with no further processing required, routes the audio signals via the tip ring sleeve connector style jack 17 through input jack input hole 28, which then sends a positive and negative left and right signal to the headphones 16.

In another third embodiment, codec 26 may amplify and process signals from both microphones 18a, 20a, bypass the analog/digital convertor and directly output their analog audio signal to speakers 18b, 20b in conjunction with audio signals from device 12 that it has converted from digital to analog and also simultaneously provided to the headphones 16. This feature is especially useful to individuals that are hearing impaired.

In operation (recording stereo sound only) when sound that is captured by microphones 18a, 20a the analog input signal travels via jack 17 through input hole 28 to codec 26 where preamp 40 amplifies the signal. Next analog/digital convertor converts the analog signal to digital and the now digital signal passes through the male connector 23 to female connector 25 into multimedia device 12 for recording. Codec 26 can optionally employ a digital signal processor 43 for additional processing.

In operation, (recording stereo sound synchronized with video recording) the multimedia device's video recording feature is deployed from the interface screen on the multimedia device which signals the internal camera to begin recording simultaneously with the initiation of a “record now” signal to the multimedia devices internal mono-microphone. Since the microphones are electrically connected to the codec (pre amp, optional amp, digital signal processor and analog to digital converter) and the codec is connected to the multimedia device through the male and female pin connectors, the multimedia device's logic controller (internal microprocessor) recognizes the existence of a connected, alternate set of stereo microphones (the default as stereo always trumps mono in the hierarchy of recording) and restricts the use of the mono microphone. The “record now” signal is routed through the male and female multi pin interface connector through the codec to the microphones to begin recording. Phantom power is initiated to the microphones. The microphone's output signal passes through the tip ring sleeve connector style jack 17 and the headphone jack input hole 28 then via the hard wires to the codec where it sequentially passes through the pre amplifier, the digital signal processor and the digital/analog convertor. Eventually, after sound processing, a set of left and right digital audio signals are set via hard wires to the male and female multi pin interface connector and into the multimedia device's digital memory where it is stored in synchronization with the video images.

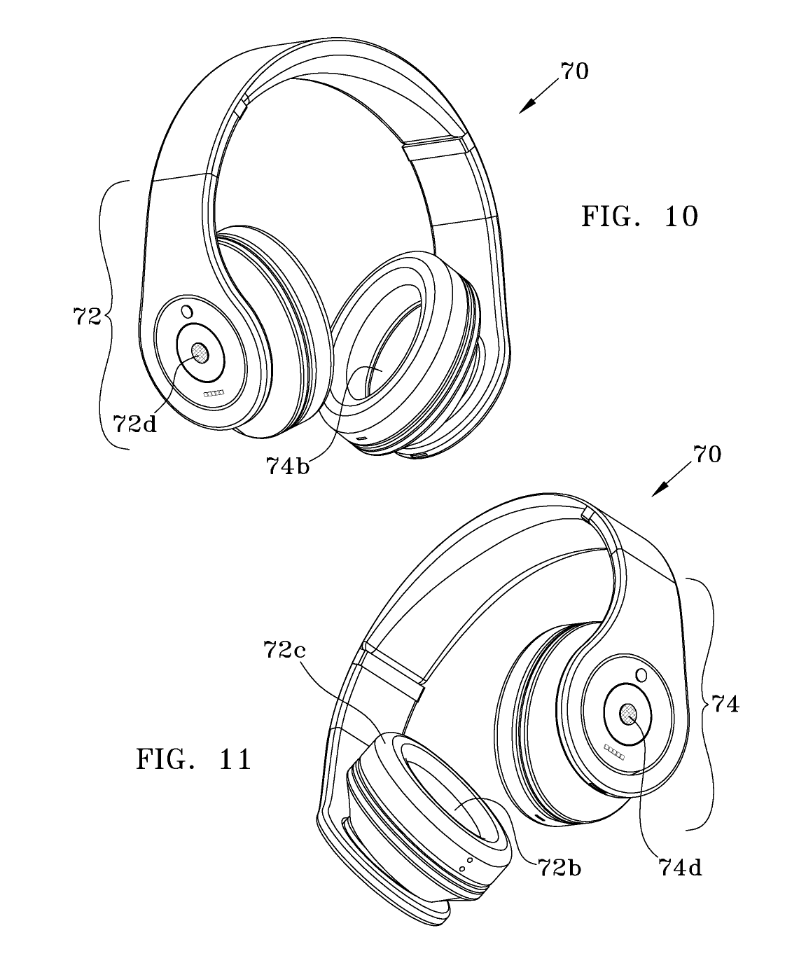

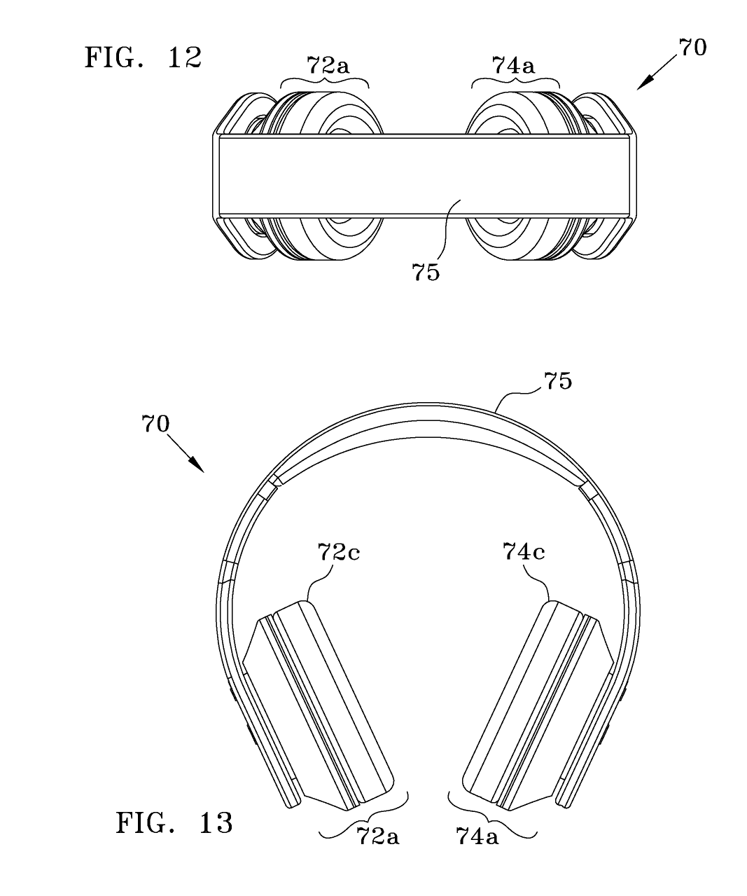

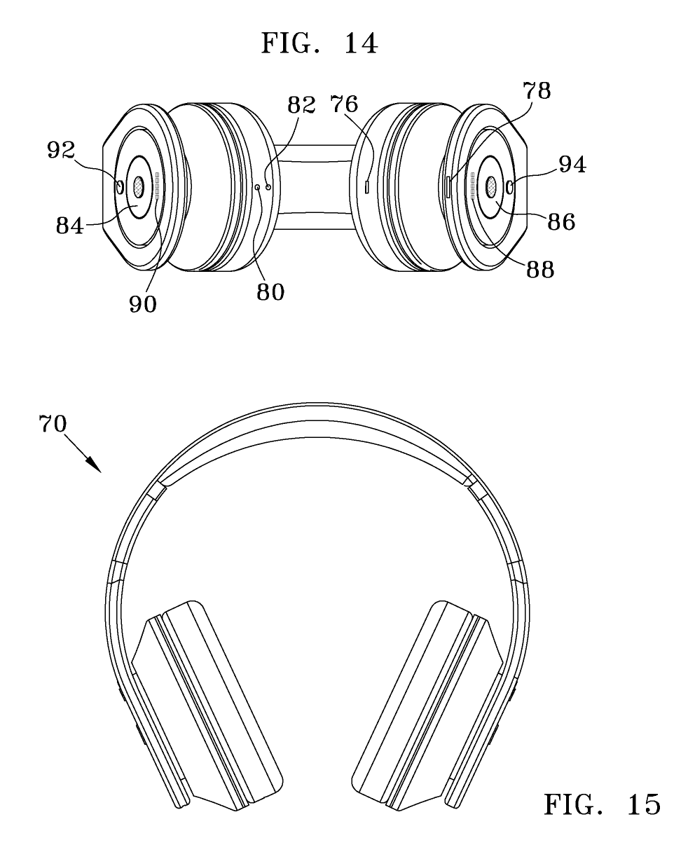

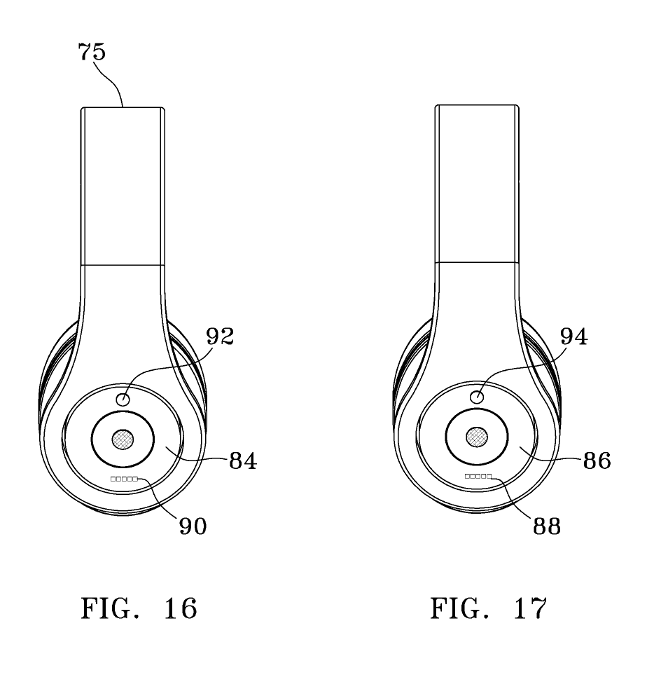

Turning to FIGS. 10-17 a fourth embodiment, circumaural (around-the-ear) audio headphones 70 are illustrated. The operation of this style of portable binaural recording and playback accessory for a multimedia device does not differ from that of the aforementioned earbud style devices, however the physical structural embodiment does.

Headphones 70 internally house a powered microprocessor with codec 26 allowing headphones 70 to be connected directly to an external electronic device such as a multimedia device 12 or any other audio source. The case of the aforementioned embodiments is eliminated. Headphones 70 comprise a left ear assembly 72, left ear cup 72a, left headphone speaker 72b, left ear microphone unit 72d, right ear assembly 74, right-ear cup 74a, right headphone speaker 74b, and right ear microphone unit 74d. Recording microphones 72d, 74d are outward facing (face away from the head of the user) and lie along the centerline of the ear canal, when placed over the user's ear. Microphones 72d, 74d are non-directional microphones, capturing sound from all directions, partially limited only by any physical barriers. Thus, microphones 72d, 74d are positioned to collect the exact same sound that would enter the ear canal, or in other words, to collect what the ear canals would capture without headphones. In this way the sound origin, direction, volume, frequencies, tonal response, etc., as captured by microphones 72d, 74d will most closely approximate the sound collected by the users' ears at the time of a recording, essentially mimicking a Head Related Transfer Function (HRTF). When reproduced, this audio recording will closely mimic the original source (of the audio waves being captured). In a manual or unprocessed version, the microprocessor would be eliminated and all functions including the level controls could be manually operated. The phantom power could be continuous.

Flexible and adjustable headband 75 connects left ear assembly 72 and right ear assembly 74. Left ear pad 72e and right ear pad 74e provide a comfort fit to the user. A rechargeable, low energy power consumption power source (not illustrated) is embedded in right-ear cup 74a, and digital cable connection 76 allows for recharging of the battery. (Although inductive charging could be utilized wherein there would be no need for any cable, as is well known in the art.) Digital cable connection 76 can also carry playback of audio recordings and capture data (audio recordings) in a single data stream. A data storage device slot 78 allows a user to insert a mini-SD card or other format media to transfer data.

The microprocessor (not visible) that is housed within the left or right ear assembly, is operatively connected to the power source as well as to the codec. Generally, but not always the codec here, contains at a minimum, the microphone pre amplifiers and the analog to digital audio convertor. Any signal processing, including but not limited to digital audio signal processors, video digital signal processors, and digital to analog or analog to digital audio convertors, are directly operative connected to the microprocessor if not integrated into that particular codec. The microprocessor is also connected to all output connectors (digital or analog) whether they be analog or digital, jacks or electrical device connection sockets (not illustrated). The microprocessor is also connected to all output connectors (digital or analog) whether they be analog or digital, jacks or electrical device connection sockets (not illustrated).

(As noted above, the actual hardware, firmware and software on the codec varies and may or may not incorporate microphone inputs, microphone amplifiers, analog to digital audio convertors, audio to digital signal processors, video digital signal processors, and digital to analog audio convertors, however at a minimumit will contain the microphone preamp for both microphones.

Additionally, if there is any onboard memory (volatile RAM, DRAM, fast CPU cache memory or non volatile flash or ROM memory), it is operatively connected to the microprocessor. Memory could also be permanently embedded in right ear assembly 74 (or left ear assembly 72). Orifice 80 is a 3.5 mm analog headphone jack. Second orifice 82 is an analog microphone output to connect to a Video recorder, such as a GoPro®. Having both digital (76) and analog connections (80, 82) provides the most flexibility to the user. All control switches for volume, power, and recording level adjustments are also wired to the microprocessor. The LED output is controlled by the microprocessor and is in operation contact with it. Similarly, the wireless communication means is also connected to the microprocessor.

Easy controls allow the user to control the functionality of headphones 70. For example, one possible arrangement could have first ring plate 84 as a depressible power button. Second depressible ring plate 86 would allow the user to toggle through four different volume level settings (low to high) and a fifth auto-setting. A right-side series of LEDs 88 serves as a visual indicator of the of the input and output levels from microphone 74d, and left-side LEDs 90 serves as a visual indicator of the of the input and output levels from microphone 72d. Button 92 is a one-touch record button, wherein the user can press button 92 to initiate recording, and hold button 92 for once second to end recording, and button 94 is used to initiate or disconnect the wireless communication means such as would be accomplished by unpairing the Bluetooth® transceiver/receiver.

Headphones 70 can record stereo sound and deliver stereo music wirelessly from any wireless communication enabled device. The user can easily pair headphones 70 to a smartphone, tablet, computer, and television to enjoy music that is reproduced with all of the details and clarity of the original sound as well as having the option to record what is heard from these sources through the headphones 70.

Fifth embodiment headphones 70 are powered and similar to the previously discussed embodiment. Microphone units 72d and 74d are powered through “phantom power” and the hardwiring of headphones 70 would utilize six conductors—three per side. Microphones 72d, 74d input signal is processed first by codec 26 prior to being transmitted to another device or transmitted to permanent memory embedded in headphones 70, or to a mini-SD card.

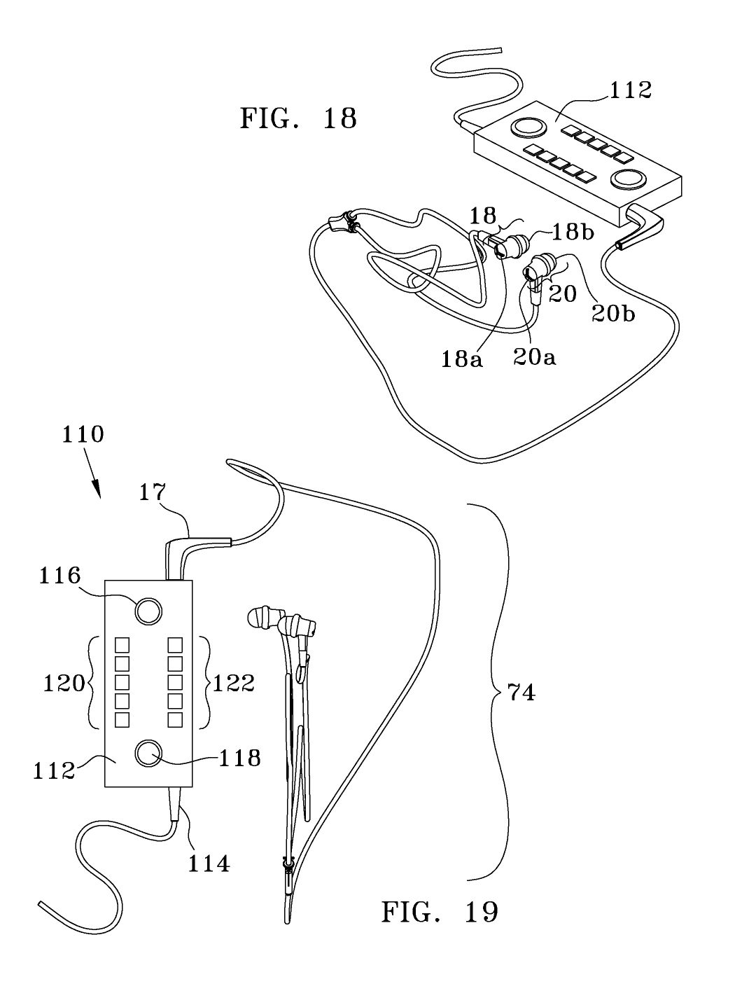

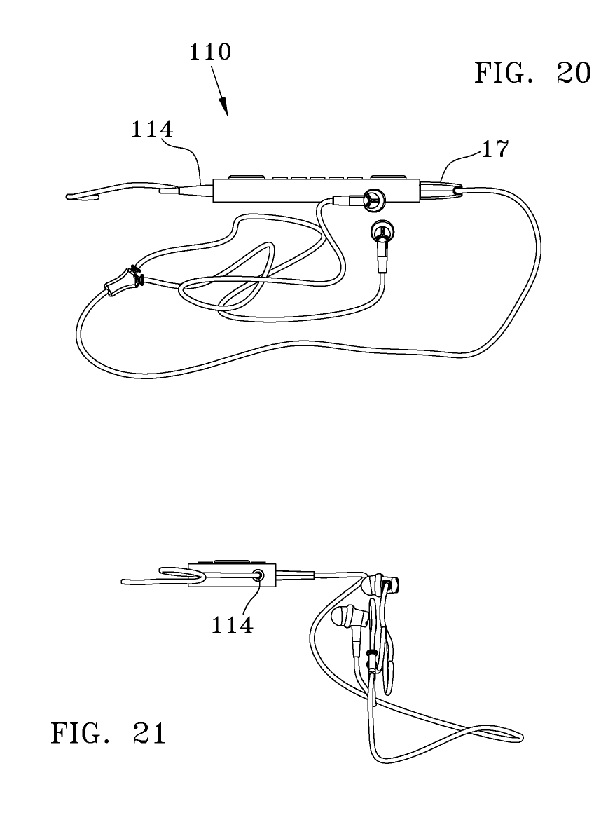

Finally, FIGS. 18-20 illustrate a sixth embodiment binaural recording and playback accessory 110 of the present invention that comprises earbud-style headphones 16 and dongle 112. Dongle 112 replaces case 14 of the first embodiment binaural recording and playback accessory 10. Headphone jack input hole (not visible but operating as headphone jack input hole 28) is incorporated into dongle 112, is adapted to receive headphone jack 17, and is matingly conformed for proper electrical connection with the various six (or seven) conductors of the aforementioned jack 17. Input hole facilitates the movement of electronic signals both ways—by reception and transmission. Transmission in the case of sound/music being played through the headphones 16, and the phantom power being sent to the microphone units 18a and 20a and reception when microphones 18a, 20a are recording. Jack 17 can easily be detached to allow for a guitar input adapter, or stereo line input adapter, etc. Connector 114 allows dongle 112 to connect to multimedia device 12. Dongle 112 houses codec 26 as well as battery 22. Top button 116 functions to power up the dongle 112 and bottom button 118 allows the user to toggle through four different volume level settings (low to high) and a fifth auto-setting. A right-side series of LEDs 122 serves as a visual indicator of the of the input and output levels from microphone 20a, and left-side LEDs 120 serve as a visual indicator of the of the input and output levels from microphone 18a.

In a final embodiment, the earbud style headphones are wirelessly connected to a simple portable unit that contains but a wireless transmitter/receiver device that receives and sends stereo information to other electronic devices. These other electronic devices have the necessary codecs to enable the desired functionality from the audio data signals provided.

The forgoing descriptions are meant to be exemplary only and should not be deemed limiting. Therefore, it is intended that this invention be limited only by the claims and the equivalents thereof.

I claim:

1. A binaural recording device with playback capabilities adapted for use with external electronic devices comprising:
a headphone set having a left earpiece and a right earpiece in an adjustably spaced arrangement;
a left speaker and an outwardly facing left recording microphone housed in said left earpiece;
a right speaker and an outwardly facing right recording microphone housed in said right earpiece;
a left microphone pre amplifier and a right microphone pre amplifier housed within a codec in said set of headphones;
a microprocessor with an audio codec housed within said set of headphones wherein said microprocessor is operative connected to said speakers, said microphones and said pre amplifiers;
a power source housed within said set of headphones and operatively connected to said microprocessor;
wherein said set of headphones has a communication means for two way communication with external electronic devices.

2. The binaural recording device of claim 1 wherein said communication means is a wireless transmitter/receiver housed within said set of headphones and operatively connected to said microprocessor and said battery for the transmission of recorded audio from said set of headphones to said external multimedia and personal computing devices.

3. The binaural recording device of claim 1 wherein said communication means is at least one output jack located on said set of headphones that is a hard wired connection to said microprocessor for the wired transmission of recorded audio from said set of headphones to said external electronic devices.

4. The binaural recording device of claim 1 further comprising at least one data storage device operatively connected to said microprocessor for the storage of recorded audio data.

5. The binaural recording device of claim 3 further comprising at least one data storage device operatively connected to said microprocessor for the storage of recorded audio data.

6. The binaural recording device of claim 5 further comprising an input socket for a removable, portable, non volatile flash memory data storage device selected from the set of removable, portable, non volatile flash memory data storage devices including PCMCIA memory cards, compact flash cards, secure digital cards, minisd cards, microsd cards, multimedia cards, memory sticks, and USB flash drives.

7. The binaural recording device of claim 4 further comprising at least one series of LED lights arranged on the surface of at least one of said set of headphone ear cups, said LED lights operatively connected to said microprocessor to illuminate responsive to at least one microphone recording audio level.

8. The binaural recording device of claim 1 further comprising an electronic on/off power switch mounted on an outer surface of an ear cup and in operative connection with said microprocessor to control power to the binaural recording device.

9. The binaural recording device of claim 8 further comprising an electronic on/off recording switch mounted on an outer surface of an ear cup and in operative connection with said microprocessor to start or stop audio recording of the binaural recording device.

10. The binaural recording device of claim 9 further comprising an electronic recording level control switch mounted on an outer surface of an ear cup and in operative connection with said microprocessor to raise or lower the audio recording level of the binaural recording device.

11. The binaural recording device of claim 10 further comprising a electronic volume level control switch mounted on an outer surface of an ear cup and in operative connection with said microprocessor to raise or lower the volume of said speakers of the binaural recording device.

12. The binaural recording device of claim 10 wherein said further electronic recording level switch also controls the volume of said speakers of the binaural recording device.

13. The binaural recording device of claim 3 wherein the number of output sockets is two, wherein one said sockets if for analog signal communication and one of said sockets is for digital signal communication.

14. A binaural recording device with playback capabilities adapted for use with multimedia devices comprising:
an earbud headphone set having a left earbud and a right earbud, said earbuds wired together at a headphone jack pin;
a left speaker and an outwardly facing left recording microphone housed in said left earbud;
a right speaker and an outwardly facing right recording microphone housed in said right earbud;
a dongle operatively connected to said earbud headphone set, said dongle comprising an operatively connected power source, codec, at least one microphone pre amplifier, an LED array to indicate an audio recording level of said microphones,
an input jack mounted on an outside surface of said dongle to accept said earbud headphone jack pin;
at least one output socket mounted on an outside surface of said dongle to accept electronic communication cable connection by said dongle from external electronic devices, said external electronic devices selected from the set of external electronic devices including personal computing devices, multimedia devices, electronic musical instruments, stereo recording and playback devices, and data storage devices;
wherein when said dongle and said earbud headphone set are operatively connected via insertion of said headphone jack pin to said input jack, such that sound from said microphones is routed electronically through said microphone pre amplifiers to said at least one output socket.

15. The binaural recording device of claim 14 further comprising, a microprocessor integrated into said dongle and wherein when said sound from said microphones is routed electronically through said microphone pre amplifiers it goes to said microprocessor and a codec to a memory and to said at least one said output socket.

16. The binaural recording device of claim 15 wherein said dongle further comprises an input socket for a removable, portable, non volatile flash memory data storage device selected from the set of removable, portable, non volatile flash memory data storage devices including PCMCIA memory cards, compact flash cards, secure digital cards, minisd cards, microsd cards, multimedia cards, memory sticks, and USB flash drives.

17. The binaural recording device of claim 15 wherein said dongle further comprises an analog to digital convertor and a digital to analog convertor all in electronic communication for the processing of signals to-and-from said microphones and to-and-from one of said connected external electronic devices.

18. The binaural recording device of claim 15 wherein said dongle further comprises a wireless communication means for communication with external multimedia and personal computing devices.
